(19) United States
(12) Patent Application Publication
(10) Pub. No.: US 2009/0033337 A1
(43) Pub. Date: Feb. 5, 2009

(54) TEMPORARY CHIP ATTACH TEST CARRIER UTILIZING AN INTERPOSER

(76) Inventor: Robert W. Pasco, Wappingers Falls, NY (US)

Correspondence Address: FREDERICK W. GIBB, III;Gibb Intellectual Property Law Firm, LLC, 2568-A RIVA ROAD, SUITE 304, ANNAPOLIS, MD, 21401, US

(21) Appl. No.: 11/833,418

(22) Filed: Aug. 3, 2007

(51) Int. Cl. H01H 31/02

(52) U.S. Cl. 324/555

(57) ABSTRACT

A testing substrate comprises internal circuitry connected to external contacts by wiring and meltable conductors are connected to the external contacts of the testing substrate. An interposer having substrate contacts on a first side is connected to the meltable conductors. The interposer is maintained apart from the testing substrate by the meltable conductors. The interposer comprises chip contacts on a second side opposite the first side. The chip contacts are adapted to temporarily connect to an integrated circuit chip being tested and burned-in. The chip contacts can have a different spacing than the substrate contacts. The interposer also includes conductive vias running from the first side to the second side and directly connecting the substrate contacts to the chip contacts.

### BACKGROUND AND SUMMARY

The embodiments of the invention generally relate to temporary chip attach (TCA) carriers.

Temporary chip attach (TCA) carriers are substrates that are temporarily joined to an integrated circuit (IC) chip for the purposes of completing testing and burn-in. After testing and burn-in, the chip is removed by applying a shear force that breaks the small (e.g., 2.8 mil squared area) connections to the TCA carrier. This (TCA Carrier) can be accomplished, for example, with alumina carriers selectively plated with Ni bumps (e.g., 1.4×2 mils) using a thin film/plating process.

The embodiments herein provide a structure that tests such a chip using an interposer between the chip and the testing/burn-in substrate. The testing/burn-in substrate comprises internal circuitry and external contacts. The internal circuitry is connected to the external contacts by internal wiring within the substrate. Meltable conductors (e.g., solder connections) are connected to the external contacts of the substrate. The interposer has substrate contacts on a first side that are connected to the meltable conductors. With embodiments herein, the interposer is maintained apart from the substrate by the meltable conductors.

The interposer also comprises chip contacts on a second side opposite the first side. In place of the conventional temporary connections between the IC chip and the substrate, with embodiments herein the chip contacts of the interposer are adapted to temporarily connect to the integrated circuit chip being tested and burned-in. If desired, the chip contacts on the second side of the interposer can have different spacings/patterns than the substrate contacts on the first side of the interposer to allow non-similar chips and testing substrates to be used together. To make electrical contact between the IC chip and the substrate, the interposer includes conductive vias running from the first side to the second side directly connecting the substrate contacts to the chip contacts.

The interposer can comprise a laminated or solid structure, and can comprise alumina, glass ceramic, etc. The conductive vias comprise conductors, such as conductor filled Nickel plated vias. The meltable conductors on the different sides of the interposer can be different. Therefore, first meltable conductors can melt at a different temperature than second meltable conductors to allow the interposer to be separated from the testing substrate and from the chip during different processing steps.

These and other aspects of the embodiments of the invention will be better appreciated and understood when considered in conjunction with the following description and the accompanying drawings. It should be understood, however, that the following descriptions, while indicating embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a schematic diagram of a temporary chip attach structure according to embodiments herein.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As mentioned above, temporary chip attach (TCA) carriers are substrates used to temporarily join a chip for the purposes of completing test and burn-in. After the testing/burn-in, the chip is removed by applying a shear force that breaks the small (2.8 mil squared area) connections to the TCA carrier. In one example, the substrates can comprise alumina carriers selectively plated with Ni bumps made using a thin film/plating process. Alternative approaches can include selectively plated glass ceramic carriers; however such selective plating processes suffer from numerous technical hurdles yet to be solved. As an improvement to alumina substrates, the present invention uses conventional glass ceramic testing substrates in combination with an interposer.

More specifically, the present invention provides a glass ceramic carrier with an inexpensive interposer (alumina or glass ceramic) with small vias (e.g., <2 mils diameter) plated with Ni to temporarily attach to the chip. The interposer can also be a laminate (plastic, FR4, etc) carrier or a ceramic carrier.

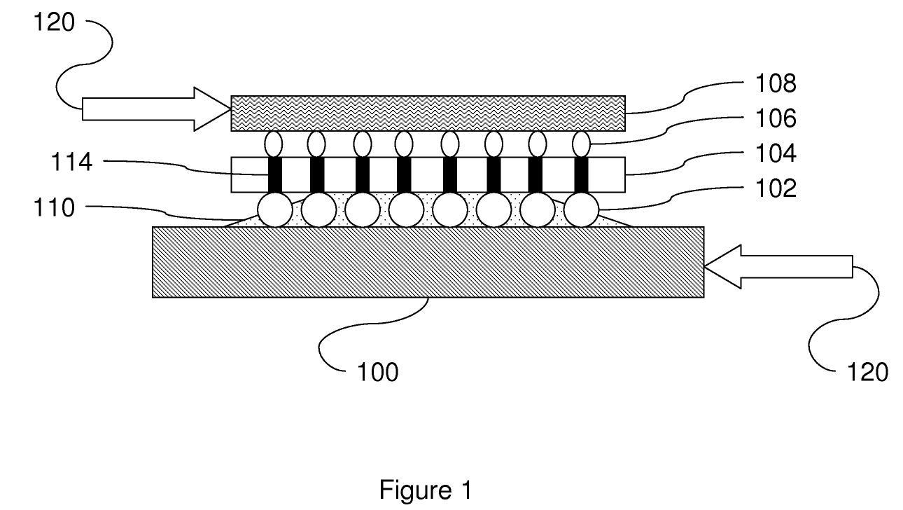

As shown in FIG. 1, the embodiments herein provide a structure that tests a chip 108 using an interposer 104 between the chip 108 and the testing/burn-in substrate 100. The testing/burn-in substrate 100 comprises internal circuitry and external contacts. The internal circuitry is connected to the external contacts by internal wiring within the substrate 100. The interposer 104 has conductive vias 114 connecting the substrate 100 to the chip 108 using meltable conductors 102/106.

The meltable conductors 102/106 (e.g., solder connections) are connected to the external contacts of the substrate 100. The interposer 104 has substrate contacts on a first side that are connected to first ones of the meltable conductors 102 (e.g., substrate conductors). With embodiments herein, the interposer 104 is maintained apart from the substrate 100 by the first meltable conductors 102. The interposer 104 also comprises chip contacts on a second side opposite the first side. The second meltable conductors 106 connect the chip contacts of the interposer to the electrical contacts of the chip 108. To make electrical contact between the IC chip 108 and the substrate 100, the interposer 104 includes conductive vias 114 running from the first side to the second side directly connecting the substrate contacts to the chip contacts.

Thus, in place of the conventional substrate-based temporary connections to the chip (directly between the IC chip and the substrate), with embodiments herein the chip contacts of the interposer 104 are used to temporarily connect to the integrated circuit chip 108 being tested and burned-in. If desired, the chip contacts on the second side of the interposer 104 can have different spacings/patterns than the substrate contacts on the first side of the interposer 104 to allow non-similar chips and testing substrates to be used together.

The interposer 104 can comprise a laminated or solid structure, and can comprise, for example, alumina, glass ceramic, etc. The conductive vias 114 comprise conductors, such as conductor filled Nickel plated vias. The meltable conductors 102/106 on the different sides of the interposer 104 can be different. Therefore, first meltable conductors 102 can melt at a different temperature than the second meltable conductors 106 to allow the interposer 104 to be separated from the testing substrate 100 and from the chip 108 during different processing steps. The shear forces are shown in FIG. 1 as arrows 120.

The temperature/strength hierarchy between the chip join 106 and interposer join 102 can be accomplished by use of larger (e.g. 5 mil) solder balls 102 on the interposer 104 relative to the smaller solder balls 106 for the chip connection. The substrate conductors 102 can also be space transformers changing the size and spacing of the contacts to the substrate. The substrate conductors 102 can comprise, for example, a relatively higher temperature braze (e.g. CuSil or AuSn or Au—Au bonding) and/or an underfill 110, when compared to the chip conductors 106. This allows the chip to be warm sheared 120 off, while the substrate 100 and interposer 104 remain intact.

By using the interposer 104 with an otherwise conventional chip carrier 100 to create the TCA carrier, the problem of TCA join and shear is separated from the temporary chip attach problem (which now only applies to the interposer 104). The interposer 104 can be simple while the TCA carrier 100 by nature is very complex. It is more cost effective and better for carrier yield to move the temporary interconnect problem to the interposer 104, which is less expensive and easier to manufacture. The interposer 104 and the substrate 100 are joined using conventional bond/assembly techniques. The interposer 104 can be almost any suitable material, such as glass ceramic, laminate, etc.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of embodiments, those skilled in the art will recognize that the embodiments of the invention can be practiced with modification within the spirit and scope of the appended claims.

What is claimed is:

1. A structure comprising:
a testing substrate comprising internal circuitry connected to external contacts by wiring;
meltable conductors connected to said external contacts of said testing substrate;
an interposer having substrate contacts on a first side connected to said meltable conductors,
wherein said interposer comprises:
chip contacts on a second side opposite said first side, wherein said chip contacts are adapted to temporarily connect to an integrated circuit chip being tested and burned-in; and
conductive vias running from said first side to said second side and directly connecting said substrate contacts to said chip contacts.

2. The structure according to claim 1, wherein said interposer comprises one of a laminated and solid structure, and comprises one of alumina and glass ceramic, and
wherein said conductive vias comprise conductor filled Nickel plated vias.

3. The structure according to claim 1, wherein said meltable conductors comprise first meltable conductors and said structure further comprises second meltable conductors connecting said chip contacts to said integrated circuit chip, wherein said first meltable conductors melt at a different temperature than said second meltable conductors.

4. A structure comprising:
a testing substrate comprising internal circuitry connected to external contacts by wiring;
meltable conductors connected to said external contacts of said testing substrate;
an interposer having substrate contacts on a first side connected to said meltable conductors, wherein said interposer is maintained apart from said testing substrate by said meltable conductors,
wherein said interposer comprises:
chip contacts on a second side opposite said first side, wherein said chip contacts are adapted to temporarily connect to an integrated circuit chip being tested and burned-in, wherein said chip contacts have a different spacing than said substrate contacts; and
conductive vias running from said first side to said second side and directly connecting said substrate contacts to said chip contacts.

5. The structure according to claim 4, wherein said interposer comprises one of a laminated and solid structure, and comprises one of alumina and glass ceramic, and
wherein said conductive vias comprise conductor filled Nickel plated vias.

6. The structure according to claim 4, wherein said meltable conductors comprise first meltable conductors and said structure further comprises second meltable conductors connecting said chip contacts to said integrated circuit chip, wherein said first meltable conductors melt at a different temperature than said second meltable conductors.

7. The structure according to claim 1, further comprising underfill adhesive, wherein said interposer is fixed to said testing substrate with said underfill adhesive.

8. The structure according to claim 1, further comprising a thin film defined structure used to define temporary chip attach contacts on through vias on said interposer.
